(19) United States
(12) Patent Application Publication
(10) Pub. No.: US 2017/0210159 A1
(43) Pub. Date: Jul. 27, 2017

(54) PRINT PAD BLANKET

(71) Applicant: James Cheng, Poway, CA (US)

(72) Inventor: James Cheng, Poway, CA (US)

(21) Appl. No.: 14/207,473

(22) Filed: Mar. 12, 2014

(51) Int. Cl. B41N 10/06

(52) U.S. Cl. CPC B41N 10/06; B41N 2210/02

(57) ABSTRACT

The invention presented is a pad printing blanket that reduces damage to pad printing heads. The industry-standard pad printing head is soft plastic, silicone or urethane. The pad is used to print designs on three-dimensional surfaces and the pad must be pressed firmly onto said surfaces. This pressure leaves permanent indentations on the print pad surface, eventually rendering the print pad useless for printing. The invention covers said print pad with a blanket of soft plastic which carries the ink for the image. Only the pad blanket contacts the printable surface, protecting the print pad and reducing the need for expensive print pad replacement.

### RELATED APPLICATIONS

This application is a Continuation-In-Part of U.S. patent application Ser. No. 13/082,789, filed Apr. 8, 2011, which is currently co-pending.

### FIELD OF THE INVENTION

This invention relates to improvements in three dimensional printing involving extending the life of print pads by means of covering said pads with flexible materials.

### BACKGROUND OF THE INVENTION

Silicone rubber printing pads are the cost effective standard for pad-transfer printing. For every printing application there is an optimum pad size, shape, and hardness (durometer). Silicone rubber pads are compressed at print time to match the exterior dimensions of the surface to be printed, permitting the entire three-dimensional surface to be reached by the printing surface.

Because the surfaces to be printed are hard, and the pad is relatively soft, welts eventually appear in the surface of the print pads resulting in tears and fractures to the silicone pad surface. These welts eventually render the pads useless and the relatively expensive pads must be replaced.

A method of covering the soft print heads with a replaceable printing surface is needed to reduce replacement cost of the printing pad. The prior art reveals a collection of alternative print pad designs, but no print pad covers. US Pat. Appl. 2008/0105145 and US Pat. Appl. 2009/0211476 are examples of the prior art. Previous patents including U.S. Pat. No. 7,651,652 to Cameron show a concentration on printing pad manufacture and shape design, not protecting the printing surface from permanent indentation or tearing.

### SUMMARY OF THE INVENTION

The present invention consists of a sheet of smooth, soft material, or a blanket, that is held over the printing surface of a silicone rubber printing pad during the printing process. The entire invention is comprised of the blanket plus several mechanisms to attach it removably to an industry-standard soft silicone printing mechanism and to keep said blanket under tension across the printing head.

The blanket is a smooth sheet that is not constrained to the shape of the printing head but is laid across heads of any shape. The blanket is significantly cheaper to produce and easy to attach and remove from the printing mechanism.

The sheet material is made of, but not limited to, silicone or polyurethane. The thickness and hardness (durometer) of the sheet material can be varied to adjust to any print application.

### BRIEF DESCRIPTION OF THE DRAWINGS

FIG. 1. Assembled print head with print head blanket

FIG. 2. Alternate view of the invention

### DETAILED SPECIFICATION

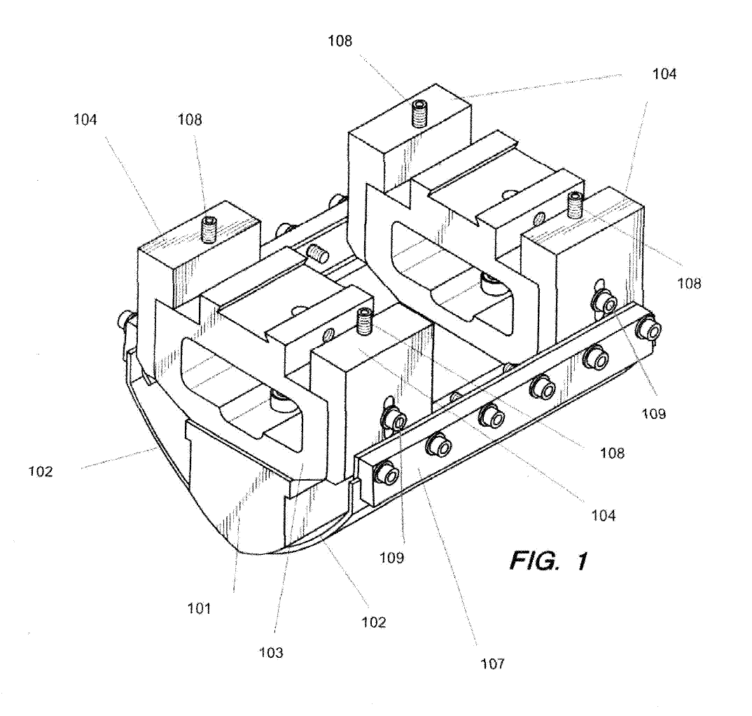

FIG. 1 illustrates an embodiment of a three-dimensional printing mechanism with a print head blanket 102 covering a silicone printing pad 101. The key parts of the invention are the pad blanket 102, the pad adapter 103, the four tension blocks 104, the pad clamps 107, and the standard printing pad 101. The printing pad 101 in FIG. 1 is in a characteristic rounded wedge shape, but printing pads 101 of any shape can be covered with this invention.

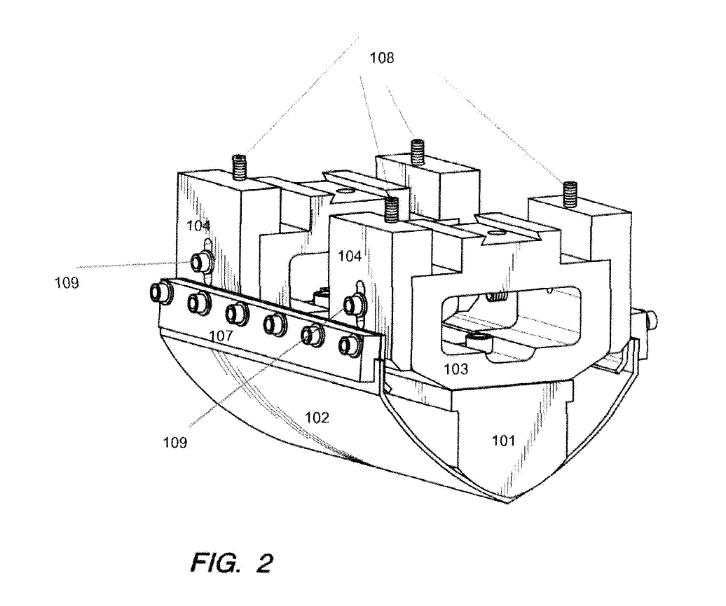

A variety of attachment devices hold the parts together; in FIG. 1 and FIG. 2, these devices are screws, but other attachment means are possible.

The pad blanket 102 is held by the pad clamp 107 on each side of the invention across the outer surface of the printing pad 101 under tension supplied by the tensions blocks 104. The pad clamps 107 are attached removably to the tension blocks by screws as shown in FIGS. 1 and 2.

The tension on the pad blanket 102 can be adjusted by means of the set screws 109 inserted in the tension blocks 104. The top screws 108 are used to attach the present invention to the rest of the printing mechanism. The invention is designed to keep an even tension on the pad blanket 102 at all points of the printing pad 101 surface by means of the pad clamps 107.

The pad blanket 102 is easily removable and can be replaced quickly when the pad blanket 102 becomes permanently indented with welts from printing on hard, three-dimensional surfaces. As a consequence, the more expensive printing pads 101 can be used for thousands of additional print impressions before becoming permanently indented, saving substantial amounts of money in the printing process.

The print blanket 102 is comprised of any soft but firm material, such as silicone or urethane. The preferred embodiment uses a print blanket 102 comprised of silicone.

This invention has other applications, potentially, and one skilled in the art could discover these. The explication of the features of this invention does not limit the claims of this application; other applications developed by those skilled in the art will be included in this invention.

What is claimed is:

1. A print head blanket system, the print head blanket system comprised of a print head, a pad blanket, a plurality of tension blocks, a plurality of pad clamps, and a pad transfer printing frame,
the print head comprised of a soft but firm material and shaped in a characteristic convex wedge shape,
the pad blanket attached to the print head removably by a plurality of pad clamps on each side of the print head, the pad blanket completely covering the print head, the pad clamps attached removably to one side of the tension blocks, the pad blanket stretched across the print head under tension supplied by the tension blocks, the tension blocks attached adjustably with tension adjustment set screws to the pad transfer printing frame,
the tension on the pad blanket adjustable by said tension adjustment set screws,
the combination of pad blanket, tension blocks and set screws providing an even tension on said pad blanket as stretched across said print head,
the pad blanket comprised of any soft and firm, non-porous material capable of holding ink to be used for pad transfer printing.

2. A print head blanket system as in claim 1, where the pad blanket is comprised of silicone.

3. A print head blanket system as in claim 1, where the pad blanket is comprised of urethane.
